(19) United States
(12) Patent Application Publication
(10) Pub. No.: US 2019/0267740 A1
(43) Pub. Date: Aug. 29, 2019

(54) CONNECTOR

(71) Applicant: Sumitomo Wiring Systems, Ltd., Yokkaichi (JP)

(72) Inventor: Yoshitaka Ito, Yokkaichi (JP)

(21) Appl. No.: 16/266,278

(22) Filed: Feb. 4, 2019

(30) Foreign Application Priority Data
Feb. 23, 2018 (JP) 2018-030942

(51) Int. Cl. H01R 13/436; H01R 13/11

(52) U.S. Cl. CPC H01R 13/4365; H01R 13/11

(57) ABSTRACT

A housing (10) includes a plurality of cavities (16) arranged side by side, guiding grooves (18) along separation walls (17) between adjacent ones of the cavities (16), and movable locks (24) formed in front of and continuous with the separation walls (17). A terminal fitting (80) includes a stabilizer (87) to be inserted into the guiding groove (18). A retainer (50) is mounted into the housing (10). The retainer (50) includes pressing portions (59) arranged side by side with the separation walls (17) and the movable locking s (24) in a front-rear direction and configured to press and displace the movable locking portions (24) toward the guiding grooves (18) so that the movable locking portions (24) are lockable to the stabilizers (87).

### BACKGROUND

### Field of the Invention

The invention relates to a connector.

### Related Art

Japanese Unexamined Patent Publication No. H07-153520 discloses a connector with a housing including a terminal accommodation holes arranged side by side and separated by separation walls. Connection terminals are inserted into the terminal accommodation holes of the housing. Deflectable locking lances project into the terminal accommodation holes from an upper wall of the housing that intersects the separation walls. A space exists between the deflectable locking lance and the housing upper wall. A front holder is fit to the housing and includes an upper pressing portion configured to press the deflectable locking lance by entering the space.

The deflectable locking lance is pressed and deflected by a terminal connecting portion of the connection terminal that is being inserted into the terminal accommodation hole. The deflected locking lance returns and locks the terminal connecting portion after insertion of the connection terminal. The upper pressing portion enters the space, presses the deflectable locking lance and acts to strengthen a locking force of the deflectable locking lance for the connection terminal when the front holder is mounted.

The terminal accommodation holes, the locking lances, the spaces and the housing upper wall are arranged vertically side by side. Thus, the connector tends to be large.

The invention was completed on the basis of the above situation and aims to provide a connector capable of miniaturization.

### SUMMARY

The invention is directed to a connector with a housing including cavities arranged side by side and separated by separation walls. Guiding grooves are arranged along the separation walls while communicating with the cavities. Terminal fittings are inserted into the cavities and each includes a stabilizer. The stabilizers are insertable into the guiding grooves. A retainer is mounted into the housing. The housing includes movable locks continuous with the separation walls in an inserting direction of the terminal fittings. Additionally, the retainer includes pressing portions arranged side by side with the separation walls and the movable locking portions in the inserting direction of the terminal fittings. The pressing portions are configured to press and displace the movable locking portions toward the guiding grooves so that the movable locking portions lock to the stabilizers.

The movable lock is pressed by the pressing portion to be displaced toward the guiding groove. Thus, the movable lock becomes lockable to the stabilizer and the terminal fitting is retained in the cavity. In this case, the movable lock is continuous with the separation wall in the inserting direction of the terminal fitting. Thus, the pressing portion is arranged side by side with the separation wall and the movable lock in the inserting direction of the terminal fitting, and the movable lock is displaced toward the guiding groove. The movable lock and the pressing portion are provided with high space efficiency, utilizing a thickness of the separation wall. As a result, the enlargement of the connector in an arrangement direction of the cavities, which is a thickness direction of the separation walls, can be avoided and the miniaturization of the connector can be realized.

The movable lock may be retracted from an insertion path for the terminal fitting in the cavity before being pressed by the pressing portion. Thus, the interference of the terminal fitting with the movable lock can be avoided in the process of insertion, and an insertion force for the terminal fitting can be suppressed.

The housing may include locking lances provided on inner walls of the cavities. The locking lances are configured to resiliently deform in the process of inserting the terminal fittings and return to lock the inserted terminal fittings. The retainer may include deflection restricting portions configured to enter deflection spaces for the locking lances. The displacement restricting portion of the retainer enters the deflection space for the locking lance. Thus, deflection of the locking lance is restricted. In this way, the terminal fitting is locked firmly by the locking lance and the movable lock.

The locking lance may be arranged on a wall intersecting the separation wall, and the displacement restricting portion may be arranged in an orientation to intersect the pressing portion. The deflection restricting portion and the pressing portion may project from a body of the retainer and may be coupled while intersecting each other. If the displacement restricting portion and the pressing portion respectively independently project from the body of the retainer, each cannot obtain sufficient strength and it may not be possible to miniaturize the connector. In that respect, since the displacement restricting portion and the pressing portion are coupled while intersecting each other according to the above configuration, sufficient strength can be ensured.

### BRIEF DESCRIPTION OF THE DRAWINGS

FIG. 1 is a front view of a housing in a connector of an embodiment of the invention.

FIG. 2 is a partial enlarged front view of the housing.

FIG. 3 is a back view of a retainer.

FIG. 4 is a partially enlarged back view of the retainer.

FIG. 5 is a side view in section in a state where the retainer is at a full locking position with respect to the housing.

FIG. 6 is a partially enlarged plan view in section in a state where the retainer is at a partial locking position with respect to the housing.

FIG. 7 is a partially enlarged plan view in section in the state where the retainer is at the full locking position with respect to the housing.

FIG. 8 is a perspective view of a terminal fitting.

FIG. 9 is a front view of the terminal fitting.

### DETAILED DESCRIPTION

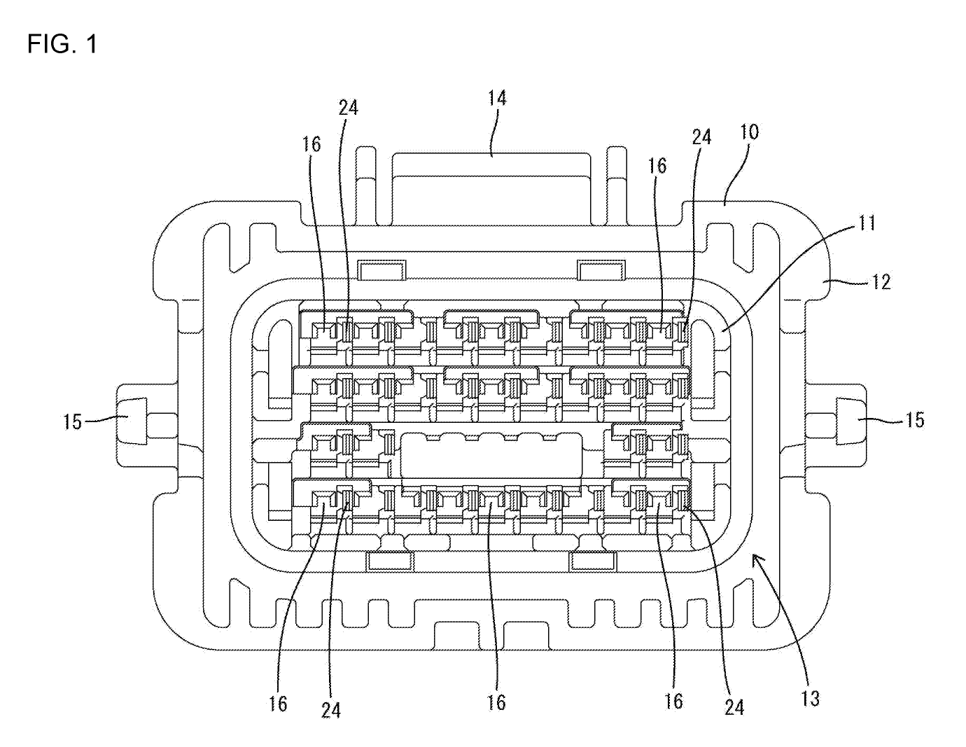

One embodiment of the invention is described with reference to FIGS. 1 to 9. A connector according to this embodiment includes a housing 10 made of synthetic resin, a retainer 50 made of synthetic resin and terminal fittings 80 made of conductive metal.

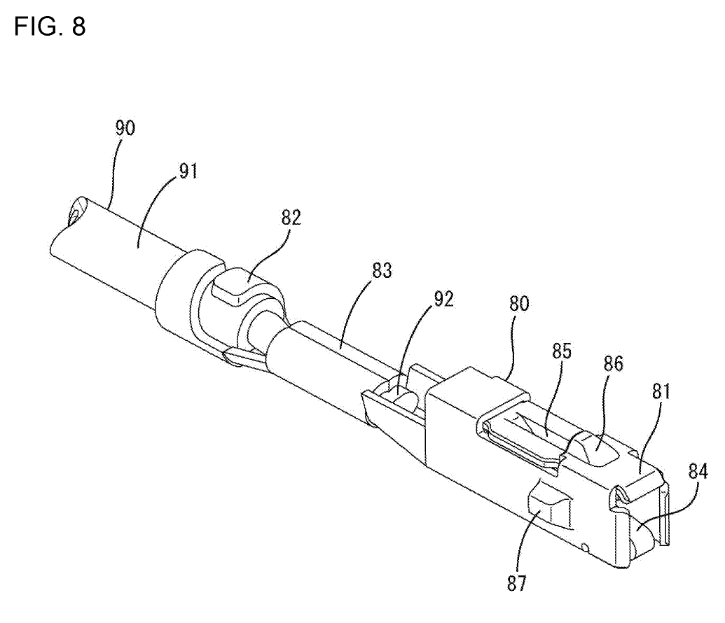

The terminal fitting 80 is formed integrally, such as by bending a metal plate and, as shown in FIG. 8, is long and narrow in a front-rear direction. A front part of the terminal fitting 80 forms a rectangular tubular connecting portion 81 that is connectable to an unillustrated mating terminal fitting. A rear part of the terminal fitting 80 forms an insulation barrel 82 to be crimped and connected to the outer periphery of a coating 91 at an end part of a coated wire 90. A wire barrel portion 83 is forward of the insulation barrel 82 and is to be crimped and connected to the outer periphery of a core 92 exposed forward of the coating 91 in the end part of the coated wire 90.

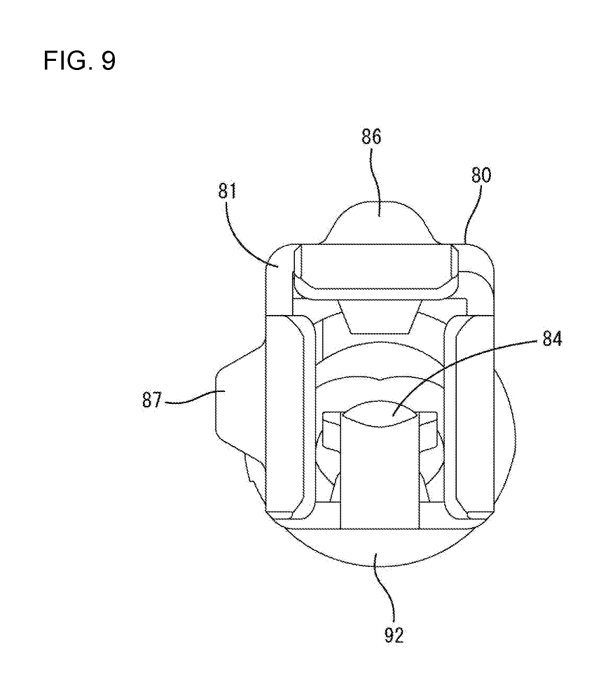

As shown in FIG. 9, the connecting portion 81 includes a resilient contact piece 84 that is deflectable and deformable inward. A male tab of the unillustrated mating terminal fitting is inserted into the connecting portion 81 and contacts the resilient contact piece 84 to contact the terminal fittings electrically.

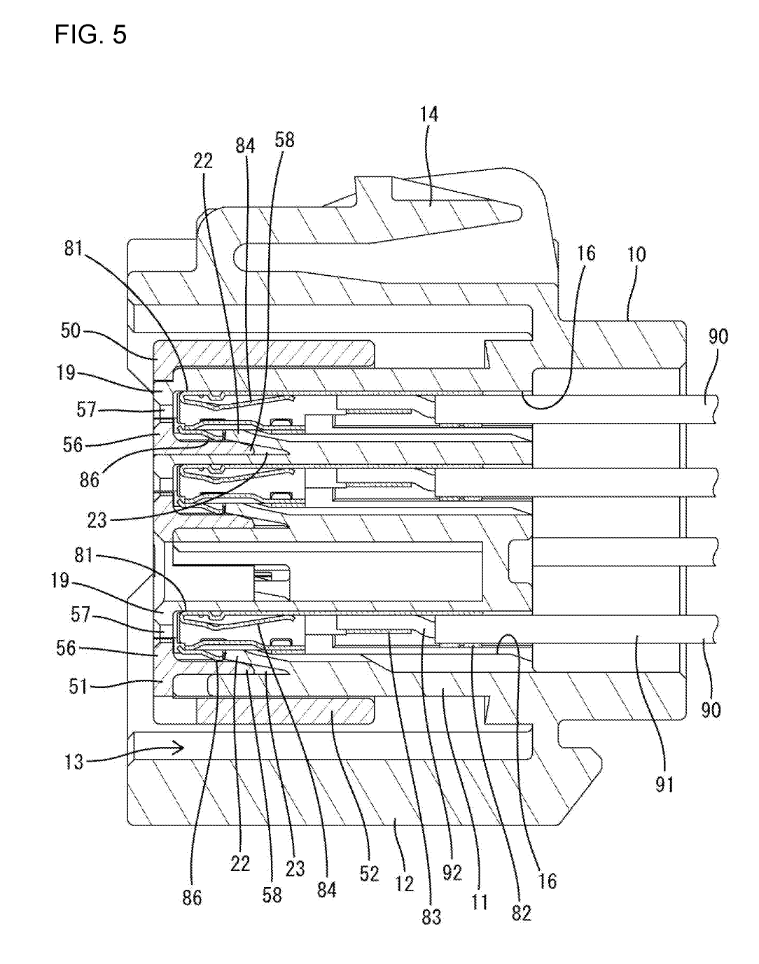

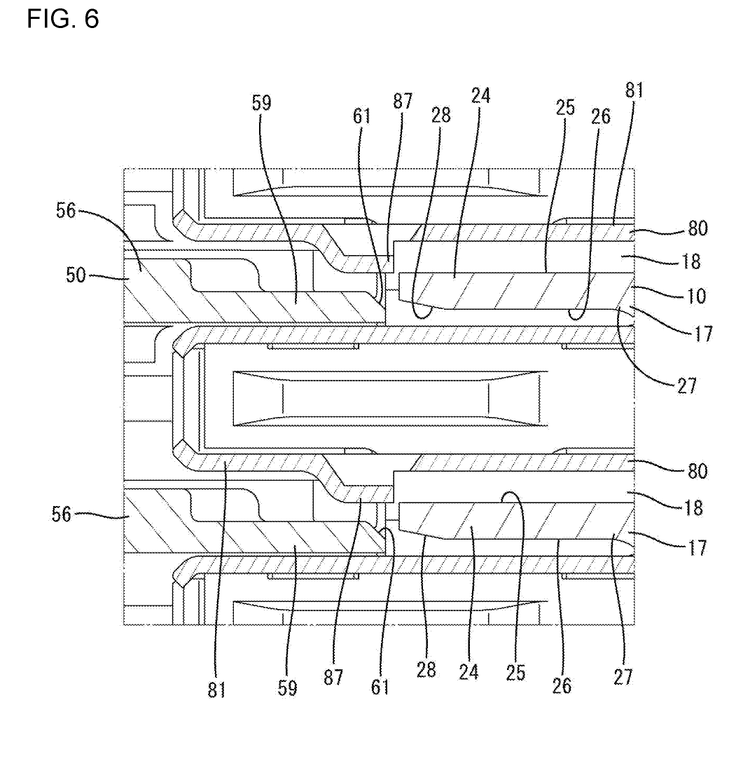

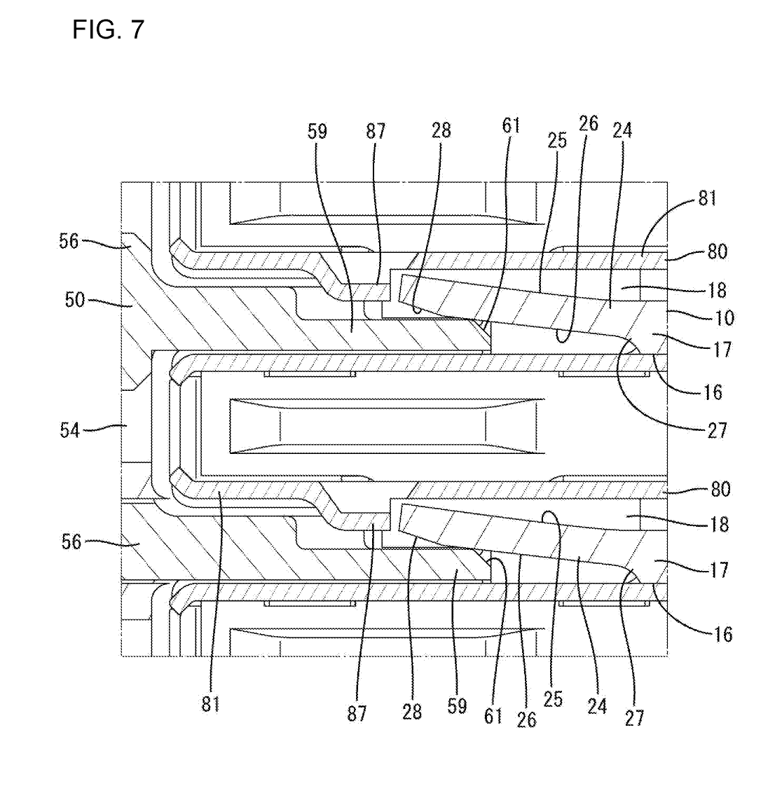

As shown in FIG. 8, the connecting portion 81 includes a recess 85 recessed inwardly in one of upper and lower walls, and a locking projection 86 bulges out on the rear end of the recess 85. Further, the connecting portion 81 includes a stabilizer 87 bulging out from a substantially vertically central part on one of the side walls intersecting the upper and lower walls. The rear end of the stabilizer 87 is arranged substantially along a width direction (see FIGS. 6 and 7) and a vertical direction behind the locking projection 86. Note that the terminal fitting 80 is inserted in an orientation vertically inverted from the one shown in FIGS. 8 and 9 into a later-described cavity 16 of the housing 10 (see FIG. 5).

As shown in FIGS. 1 and 5, the housing 10 is composed of a housing body 11 including cavities 16 and a fitting tube 12 surrounding the outer periphery of the housing body 11. A space between the housing body 11 and the fitting tube 12 forms a connection space 13 into which a receptacle of an unillustrated mating connector is to be fit from the front. Note that the male tabs of the mating terminal fittings project into the receptacle and conductively contact to the connecting portions 81 of the terminal fittings 80 when the connectors are connected.

A lock arm 14 projects on an outer surface of an upper wall of the fitting tube 12 and functions to lock the mating connector to hold the connectors in a connected state. Shafts 15 project on outer surfaces of both side walls of the fitting tube 12. An unillustrated lever is supported rotatably on the respective shafts 15.

The cavities 16 penetrate through the housing body 11 in the front-rear direction and are aligned and arranged in rows in the width direction and in a plurality of stages in a height direction. The cavities 16 adjacent in the width direction are partitioned by separation walls 17. Rearwardly open guiding grooves 18 extend in the front-rear direction along the separation walls 17 of the housing body 11 while communicating with the cavities 16 (see FIGS. 6 and 7). The guiding grooves 18 are provided individually for the respective cavities 16 and also are in outer end surfaces of the cavities 16 located at widthwise end positions.

The terminal fittings 80 are inserted into each cavity 16 of the housing body 11 from behind so that the stabilizer 87 enters the guiding groove 18 to guide the insertion of the terminal fitting 80. If the terminal fitting 80 is inserted in an inserting posture different from proper one, the stabilizer 87 contacts the rear surface of the housing body 11 to restrict the insertion of the terminal fitting 80. Thus, the stabilizer 87 prevents inversed insertion of the terminal fitting 80 into the cavity 16.

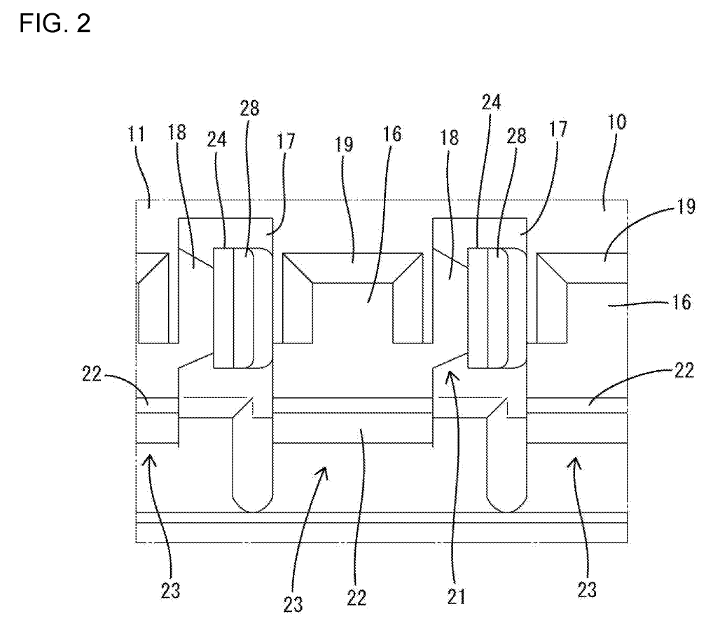

As shown in FIG. 2, the housing body 11 includes cavity front portions 19 exposed on a front surface and in the form of U-shaped frames defining front end upper parts of the cavities 16, and a mounting space 21 for the retainer 50 around the cavity front portions 19.

Further, the housing body 11 includes a deflectable and deformable locking lance 22 projecting obliquely forward into the cavity 16, as shown in FIG. 5, on one of upper and lower walls (lower wall as shown) intersecting the separation wall 17. A tip part of the locking lance 22 is located in an insertion path for the terminal fitting 80 in the cavity 16 in a natural state before deflection and deformation. As shown in FIG. 2, a deflection space 23 is defined between the locking lance 22 and a facing wall surface (including a part of the cavity front portion 19) and the locking lance 22 is arranged in an exposed manner so as to be visually confirmable through the mounting space 21 before the retainer 50 is mounted.

The housing body 11 includes movable locks 24 continuous with and projecting forward from the separation walls 17. As shown in FIGS. 6 and 7, each movable lock 24 is resiliently inclinable with a base end 27 connected to the separation wall 17 as a support. Each movable lock 24 has an inner surface 25 facing the cavity 16 on a displacement side and an outer surface 26 on an opposite side. A thickness between the inner and outer surfaces 25, 26 of the movable lock 24 is smaller than that of the separation wall 17.

The inner surface 25 of the movable lock 24 is continuous with a groove surface of the corresponding guiding groove 18 without a step and is arranged in the front-rear direction along the groove surface of the guiding groove 18 in a state before displacement (see FIG. 6). The outer surface 26 of the movable lock 24 is connected via a step to a wall surface of the corresponding separation wall 17 (side opposite to the guiding groove 18) at the base end 27, and is arranged along the front-rear direction except at a leading end part. The leading part of the outer surface 26 of the movable locking portion 24 forms a slope 28 linearly cut to extend rearward. Further, as shown in FIG. 2, the movable lock 24 has a substantially rectangular shape long in the vertical direction along the separation wall 17 in a front view.

The retainer 50 is a front retainer and, as shown in FIG. 5, is composed of a body 51 arranged on a front side of the housing body 11 and a peripheral wall 52 projecting rearward from an outer peripheral part of the body 51 and arranged to cover the outer periphery of a front part of the housing body 11.

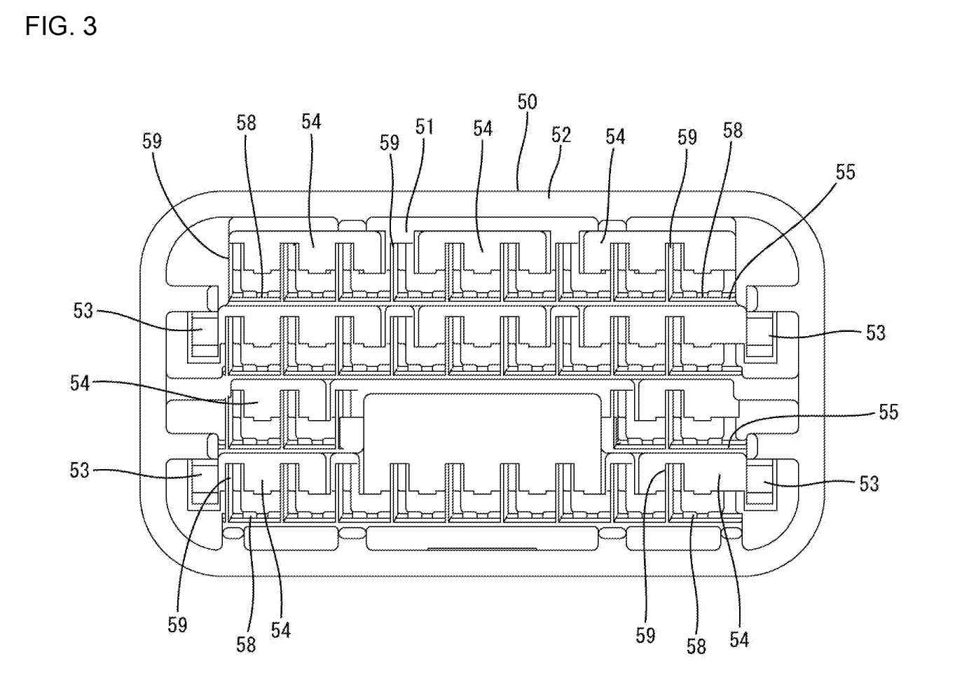

As shown in FIG. 3, locks 53 for partial locking and full locking are provided on both widthwise sides of the peripheral wall 52. The retainer 50 is movable in the front-rear direction to a partial locking position and a full locking position with respect to the housing 10 and is held at each of the partial locking position and the full locking position by the locks 53 being locked to the housing body 11.

The body 51 includes windows 54 long in the width direction at positions corresponding to the respective stages of the cavities 16 of the housing body 11. The body 51 includes beams 55 connecting lower sides of the respective windows 54 in the width direction in a rear surface.

The body 51 includes front walls 56 defining front end lower parts of the respective cavities 16 while defining the respective windows 54. When the retainer 50 reaches the full locking position, the front walls 56 are fit into the mounting space 21 of the housing body 11 and tab insertion holes 57 into which the male tabs of the mating terminal fittings are to be inserted are formed between the front walls 56 and the cavity front portions 19 (see FIG. 5).

Deflection restricting portions 58 project rearward from the respective front walls 56 of the body 51 of the retainer 50. Each deflection restricting portion 58 is a plate along the width direction and, as shown in FIG. 5, can restrict the deflection of the corresponding locking lance 22 by entering the deflection space 23 for the locking lance 22.

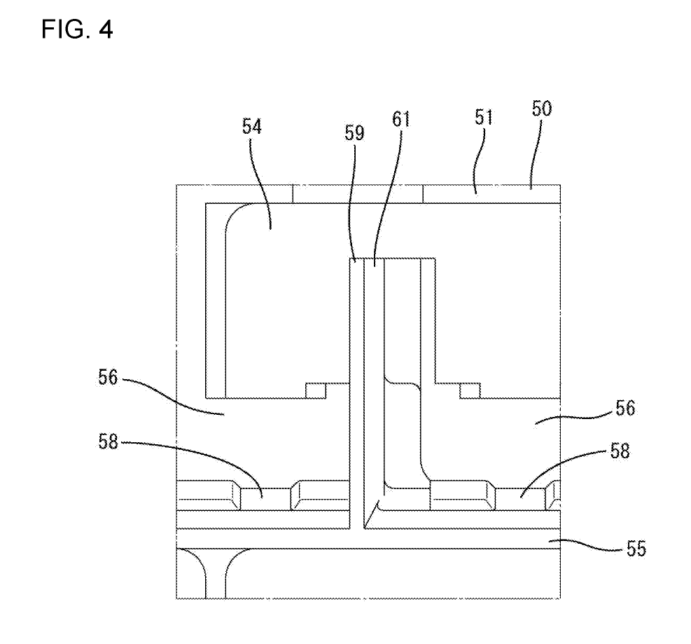

Pressing portions 59 project rearward from the body 51 of the retainer 50. Each pressing portion 59 is a plate along a vertical direction perpendicularly intersecting an extending width direction of each deflection restricting portion 58 and integrally coupled to the corresponding deflection restricting portion 58. Specifically, as shown in FIG. 4, the pressing portion 59 rises from one widthwise end of the deflection restricting portion 58 on one widthwise end of the front wall 56 of the body 51 and forms a substantially L shape together with the deflection restricting portion 58 in a back view.

When the retainer 50 is at the partial locking position, the pressing portions 59 partially overlap the respective movable locks 24 and are arranged side by side with the movable locks 24 in the front-rear direction while being shifted from the movable locks 24 in the width direction, as shown in FIG. 6. When the retainer 50 is at the full locking position, the respective pressing portions 59 press and displace the respective movable locking portions 24 toward the corresponding guiding grooves 18, as shown in FIG. 7. Each pressing portion 59 includes a cut sliding slope 61 on a leading end part of an inner surface for pressing the movable lock 24. The sliding slope 61 of each pressing portion 61 has a larger angle of inclination with respect to the front-rear direction than the slope 28 and faces a leading end part of the slope 28 of each movable lock 24, as shown in FIG. 6, when the retainer 50 is at the partial locking position.

Next, functions and effects of this embodiment are described.

The retainer 50 initially is held at the partial locking position with respect to the housing body 11. In that state, the terminal fittings 80 are inserted into the cavities 16 of the housing body 11 from behind. Thus, the stabilizers 87 enter the guiding grooves 18 to guide the insertion of the terminal fitting 80. In a final stage of the process of inserting the terminal fitting 80 into the cavity 16, the locking projection 86 of the connecting portion 81 interferes with the locking lance 22 to deflect and deform the locking lance 22 toward the deflection space 23. During this time, the movable lock 24 is retracted from the insertion path for the terminal fitting 80 in the cavity 16, in particular, retracted from the guiding groove 18. Thus, the terminal fitting 80 does not substantially contact the movable lock 24 including the stabilizer 87 in the process of insertion into the cavity 16.

When the terminal fitting 80 is inserted properly into the cavity 16, the front end of the connecting portion 81 is stopped in contact with the cavity front portion 19 and the locking lance 22 resiliently returns and is arranged to lock the rear end of the locking projection 86. The locking lance 22 locks the locking projection 86, thereby restricting the rearward escape of the terminal fitting 80 from the cavity 16 (see FIG. 5). The locking projection 86 is kept in a state avoiding interference with the connecting portion 81 by facing the recess 85. In this state, the movable lock 24 is outward of the stabilizer 87 in the width direction and slightly behind the rear end of the stabilizer 87 (see FIG. 6).

Subsequently, the retainer 50 is pushed rearward toward the full locking position. In the process of moving the retainer 50, the tips of the pressing portion 59 and the movable lock 24 contact and the slope 28 of the movable lock 24 slides on the sliding slope 61 of the pressing portion 59, thereby applying a pressing force acting toward the guiding groove 18 in the inner surface 25 to the movable lock 24. In this way, the movable lock 24 is pressed by the pressing portion 59 and inclined and displaced toward the guiding groove 18 with the base end 27 as a support.

When the retainer 50 reaches the full locking position, the pressing portion 59 reaches an area of the outer surface 26 of the movable lock 24 behind the slope 28 and the tip of the movable lock 24 deeply enters the guiding groove 18 (see FIG. 7). In this way, the tip of the movable lock 24 is arranged to face and lock to the rear end of the stabilizer 87.

When the retainer 50 reaches the full locking position, the deflection restricting portion 58 enters the deflection space 23 for the locking lance 22 to restrict deflection of the locking lance 22. The terminal fitting 80 is substantially triply locked by the locking lance 22 lockable to the locking projection 86, the deflection restricting portion 58 for restricting deflection of the locking lance 22 and the movable lock 24 lockable to the stabilizer 87.

As described above, the movable lock 24 is pressed by the pressing portion 59 to be displaced toward the guiding groove 18 and to lock to the stabilizer 87 so that the terminal fitting 80 is retained reliably in the cavity 16. In this case, the movable lock 24 is in front of and continuous with the separation wall 17, the pressing portion 59 is arranged side by side with the separation wall 17 and the movable lock 24 in the front-rear direction, and the movable lock 24 is inclined and displaced toward the guiding groove 18 into which the stabilizer 87 enters. Thus, the movable lock 24 and the pressing portion 59 are provided in a thickness direction of the separation wall 17 with high space efficiency. Specifically, the movable lock 24 and the pressing portion 59 are arranged within a thickness range of the separation wall 17 before the displacement of the movable lock 24 in the width direction of the housing 10, and are arranged within a range obtained by adding the thickness of the separation wall 17 and the depth of the guiding groove 18 after the displacement of the movable lock 24. Thus, the housing 10 is not enlarged in the width direction.

The movable lock 24 is retracted from the insertion path for the terminal fitting 80 in the cavity 16 in the natural state before displacement. Thus, the movable lock 24 does not interfere with the terminal fitting 80 being inserted. As a result, an insertion force for the terminal fitting 80 is low.

The terminal fitting 80 is locked resiliently by the locking lance 22 in addition to being locked by the movable lock 24, and the deflection of the locking lance 22 is restricted by the deflection restricting portion 58 of the retainer 50. Thus, reliability in retaining the terminal fitting 80 in the cavity 16 is enhanced.

The separation wall 17 between the cavities 16 that are adjacent in the width direction is provided with the movable lock 24 and the locking lance 22 is provided on one of the upper and lower walls intersecting the separation wall 17. The pressing portion 59 and the deflection restricting portion 58 of the retainer 50 are coupled while intersecting each other to correspond to the movable lock 24 and the locking lance 22. Thus, sufficient strength can be ensured for a part from the pressing portion 59 to the deflection restricting portion 58 while achieving miniaturization of the retainer 50.

Other embodiments are described briefly below.

The locking lances may be omitted from the housing and the terminal fittings may be retained only by the movable locking portions. According to this configuration, the deflection restricting portions can be omitted from the retainer and further miniaturization of the connector can be realized.

The retainer may be configured to reach the full locking position without stopping at the partial locking position when being mounted into the housing body.

Either the slope portions of the movable locking portions or the sliding slopes of the pressing portions may be omitted.

### LIST OF REFERENCE SIGNS

10 . . . housing
16 . . . cavity
17 . . . separation wall
18 . . . guiding groove
22 . . . locking lance
24 . . . movable lock
50 . . . retainer
51 . . . body
58 . . . deflection restricting portion
59 . . . pressing portion
80 . . . terminal fitting
86 . . . locking projection
87 . . . stabilizer

What is claimed is:

1. A connector, comprising:
terminal fittings (80) each including a stabilizer (87);
a housing (10) including cavities (16) arranged side by side via separation walls (17), the terminal fittings (80) being insertable into the cavities (86), and guiding grooves (18) arranged along the separation walls (17) while communicating with the cavities (16), the stabilizers (87) being insertable into the guiding grooves (18); and
a retainer (50) to be mounted into the housing (10);
the housing (10) including movable locks (24) continuous with the separation walls (17) in an inserting direction of the terminal fittings (80); and
the retainer (50) including pressing portions (59) arranged side by side with the separation walls (17) and the movable locks (24) in the inserting direction of the terminal fittings (80) and configured to press and displace the movable locks (24) toward the guiding grooves (18) so that the movable locks (24) are lockable to the stabilizers (87).

2. The connector of claim 1, wherein the movable lock (24) is retracted from an insertion path for the terminal fitting (80) in the cavity (86) before being pressed by the pressing portion (59).

3. The connector of claim 2, wherein:
the housing (10) includes locking lances (22) provided on inner walls of the cavities (86) and are configured to be resiliently deformed in the process of inserting the terminal fittings (80) and return and be lockable to the terminal fittings (80) after the insertion of the terminal fittings (80); and
the retainer (50) includes deflection restricting portions (58) configured to enter deflection spaces for the locking lances (22).

4. The connector of claim 3, wherein:
the locking lance (22) is arranged on a wall surface intersecting the separation wall (17), and the deflection restricting portion (58) is arranged in such an orientation as to intersect the pressing portion (59); and
the deflection restricting portion (58) and the pressing portion (59) project from a body portion of the retainer (50) and are coupled while intersecting each other.
